(19) United States
(12) Patent Application Publication
(10) Pub. No.: US 2016/0007810 A1
(43) Pub. Date: Jan. 14, 2016

(54) Ergonomic Shower Tray and Method for Manufacturing Same

(71) Applicant: SOLID SOFT TRAY, S.L., Valencia (ES)

(72) Inventor: Javier Andres Alemany, Onda (castellon) (ES)

(73) Assignee: Solid Soft Tray, S.L., Valencia (ES)

(21) Appl. No.: 14/765,427

(22) PCT Filed: Feb. 1, 2013
(86) PCT No.: PCT/ES2013/070056

§ 371 Date: Aug. 3, 2015

(51) Int. Cl. A47K 3/40; B05D 3/00

(52) U.S. Cl. CPC A47K 3/405; B05D 3/007

(57) ABSTRACT

Ergonomic shower tray (1), comprising: a flat base surface (2); a top surface (3a) opposite to said flat base surface (2), wherein said top surface (3a) comprises on its perimeter area, flat surfaces suitable for the placement of a screen or similar, at least one drainage channel (4) and a drainage area (3b) around said channel comprising at least one slope (3) with a gradient comprised in the range defined between 0.5% and 2% gradient, falling into the at least one drainage channel (4) and an area (3c) adjacent to the drainage area (3b) defined by the remaining flat surface of said top surface (3a) of the shower tray (1); wherein the thickness of the tray is comprised between 1.75 cm and 3.25 cm and wherein the material of said shower tray (1) comprises integral polyurethane defining a plurality of cavities internal to the shower tray (1), providing it with elasticity such that the tray is adaptable to the footprint of a user.

### TECHNICAL FIELD OF THE INVENTION

The present invention is related to an ergonomic shower tray and to the manufacturing method of the same; wherein the shower tray and the manufacturing method fall in the field of bathrooms and toilets and, preferably, of domestic bathrooms.

This manufacturing method has as purpose the obtainment of an ergonomically designed shower tray, and the production of which includes a series of small steps, without having to carry out a pre-mixture of materials for subsequent injection into a mould, and suitable for arrangement on flat surfaces of houses or public bathrooms.

### BACKGROUND OF THE INVENTION

By way of introduction, the currently used shower moulds are, preferably, made of ceramic material, acrylic or stainless steel; i.e., these are rigid materials that are attached on-site on a support or framework by means of a mortar-type bonding material, plaster or other adhesive paste.

Such trays have various disadvantages from the fragility against impacts, pronounced in ceramic material, to the difficulty of forming varied geometries because of the difficulty of machinability of such materials, since they are normally very abrasive and, therefore, increasing the machining cost of the shower tray to be manufactured.

For this reason, to solve said problem, different applications are known wherein the possibility of forming and manufacturing shower trays with different materials is considered, see for example the Spanish patent with publication number 2329641, which describes the manufacturing method of a shower tray, which is manufactured by molding with a flexible material that must necessarily be embodied in reduced thickness to suit the work floor and wherein said work floor must necessarily comprise a certain concavity or fall, previously built, towards an interior point wherein a drainage channel is placed, and therefore a flexible shower tray is obtained since it is made of flexible materials, but that needs a tilt towards the drain on the support or work floor, increasing the time of construction of the support and, therefore, requiring more expensive and complicated facilities.

For this reason, in view of the difficulties referred to above, there is the need for the emergence of a new shower tray and forming method of the same which allows its placement on surfaces or supports without previously building slopes, falls or any concavity on said surfaces or supports towards a drainage point, that additionally provides it with a suitable degree of elasticity so that it adapts to the footprint of the user, as well as requiring a small number of stages in its manufacture which directly results in a reduced manufacture cost of said product.

### DESCRIPTION OF THE INVENTION

The present invention is related to an ergonomic shower tray, and to the manufacturing and forming method thereof; wherein said shower tray comprises the following technical features:
a flat base surface suitable for being placed on a flat surface, hereinafter referred to as support;
a top surface opposite to said flat base surface, wherein said top surface comprises in the perimeter area, flat surfaces suitable for the placement of a screen or similar, at least one drainage channel and a drainage area around said drainage channel comprising at least one slope that falls towards at least one drainage channel and an area adjacent to the drainage area defined by the remaining flat surface of said top surface of the shower tray; and
wherein the material of said shower tray comprises integral polyurethane defining a plurality of cavities internal to the shower tray, giving rise to a shower tray provided with certain elasticity and adaptable to the footprint of a user.

The existence of two different areas on the top surface of the ergonomic shower tray object of invention is highlighted, the drainage area of the shower tray, wherein it is defined at least one slope suitable for forcing the evacuation of water located on the shower tray and the flat area defined by the perimeter area suitable to be able to attach a screen or similar and the flat area adjacent to the drainage area.

In relation to the type of material and to the cavities that form part of the shower tray, it is observed that such cavities allow to give elasticity to the shower tray object of invention, in such a way that said shower tray fits the footprint of the user when they are placed over the tray, improving the ergonomics of the product and, in this way, it improves the grip of said user on the shower tray, such that it increases the friction between foot and shower tray improving the security perceived by the user.

It is observed that the shower tray comprises a base surface, which may comprise different geometries based on the geometry of the support on which it will be installed, but that said base surface is flat, therefore masonry or expensive or complicated facilities are not required to manufacture the support, but it is the shower tray itself the one that comprises said at least one slope located on the surface where the user is located, i.e., in the drainage area of the top surface opposite to said flat base surface; and wherein said slope falls towards said at least one drainage channel to remove the water from the area of the shower tray in a gravitational way.

This solution results in the shower tray comprising a thickness greater than the average thickness of shower trays, since the slope must be such that it allows a proper evacuation of the water from the shower through said at least one drain, but where the thickness increase compensates for the cost of having to manufacture the slopes in the own support, and reducing the workload of the masons responsible for its manufacturing and forming. Such thicknesses are comprised in the range defined between 2 cm and 3 cm with a tolerance of +/−0.25 cm; then they differ from the usual thicknesses of the currently known shower trays, such and as described with the aim of ensuring the proper evacuation of water and providing the shower tray with an elasticity ergonomic for the user.

It is considered the possibility that said at least one slope comprises a gradient in the drainage area comprised in the range defined between 0.5% and 2% gradient, ensuring the proper evacuation of the water from the shower towards said at least one drain.

It is also considered the possibility that the top surface of the shower tray comprises two areas:
A wet area defined by the drainage area comprising said at least one slope and part of the perimeter flat surfaces suitable for the placement of a screen or similar; i.e., the area wherein the user showers and that logically comprises the area of the slopes as well as part of the perimeter flat surfaces where the possibility of placing the screen or partition is considered; and
a drying area defined by the remaining flat surface of said top surface of the shower tray, which is located preferably in the area opposite to the drainage channel and helps the user enter and exit the shower, since it comprises the flat area adjacent to the drainage area and part of the perimeter flat surfaces.

It is considered the possibility that the drainage area or wet area of the top surface of the shower tray comprises a rectangular shape with a longest side comprised between 110 cm and 150 cm.

Equally, it is considered the possibility that the drainage channel is displaced with respect to the geometric centre of the shower tray, regardless of the shape that the drainage area or wet area of said shower tray has.

Moreover, since the shower tray is provided with elasticity, it is considered the possibility that it comprises a plate on the flat base surface, aligned in correspondence with the drainage channel of the top surface, which gives consistency to said section and prevents collapses or irregularities on the base surface of the shower tray that could cause leaks, water leaks, misalignments or the like when having to thread on the underside a drain or siphon system in the shower tray.

Preferably, the material of the aforementioned plate is made of galvanized iron or with similar characteristics, of reduced thickness and at least partially embedded in the base surface of the shower tray.

As for the manufacturing method of the shower tray described above, it is considered the possibility that, from a mould comprising the geometry of said shower tray, such method comprises the following stages:

a) Injecting inside the mould a mixture of materials comprising polyol and isocyanate for obtaining integral polyurethane, foaming agents and polyurethane pigment;

b) waiting for a foaming and reaction time of said previous mixture of materials, until the cooling of the mixture of materials that makes up the shower tray; and

c) removing the shower tray (1) formed inside of said mould.

Stage a), shows that the mixture of materials comprises foaming agents, and therefore there is entrained air inside the shower tray which allows providing it with a degree of elasticity, capable even of being slightly deformed when the user stands on this.

Therefore, it is observed that the shower tray is manufactured as a product derived from a reaction, thus it occurs in a single step summarized in the injection of a mixture of materials already prepared, which is left to react and to cool down for the extraction of the finished part.

In relation to the arrangement of the shower tray manufactured to a particular geometry of a flat support, it is usual to have to cut the shower tray according to the geometry of said support, such that when it is cut a plurality of interior cavities corresponding to the inclusion of air inside are shown, and in order to prevent the entry of water through such cavities, the possibility of finishing the walls of the cuts with a type material, e.g. polyurethane putty and certain percentage of water is envisaged, such that the passage of water to the inside of the shower tray is prevented.

This drawback is not reflected on the top surface of the shower tray, since the injection molding manufacturing process itself and the pressure at which said mixture of materials is injected, results in the formation of a waterproof surface or skin of certain thickness (normally around 2 mm) on the surfaces of the shower tray preventing the passage of water or the formation of traces of water due to osmosis.

As for the mixture of materials, it is considered the possibility that in stage a), the mixture of materials comprises polyol and isocyanate for obtaining integral polyurethane, wherein preferably, the obtainment of integral polyurethane is carried out according to the selection of a mixing program of isocyanate and polyol at 50%.

It is also considered the possibility that in stage a), the mixture of materials comprises polyurethane pigments, which are added to the original mixture of materials in a preferred percentage between 2% and 5% of the total mixture of materials.

As for the stages prior to the injection of the mixture of materials described above, it is considered the possibility that prior to stage a), the method comprises the following stages:

a1) Applying mould-release agents on the inner surface of the mould that forms the geometry of the shower tray to be formed; and

a2) painting said at least one inner surface of the mould of a final colour of the shower tray to be formed.

Where, preferably, the mould-release agents comprise a mixture of diluted silicone and semi-transparent wax, the application of which is carried out by means of projection spray gun on the, at least one, inner surface that forms the external geometry of the shower tray.

Complementary, it is considered the possibility that after stage c), the method comprises the following stages:

c1) deburring the burrs present in the shower tray formed; and

c2) cleaning the mould-release agents from the surface of the shower tray formed.

Once the shower tray is clean, the shower tray is protected by means of a film, and a quality control is performed over said shower tray.

Subsequently, it is considered the possibility of selecting the grill of the drain to be installed, and the corresponding coupling means of it to the shower tray formed.

Additionally, and in relation to the adaptation of the geometry of the shower tray to the geometry of the flat support on which it is placed, it is considered the possibility that after stage c), the method comprises the following stages:

d) Cutting the shower tray formed according to the measures of a support on which it is going to be placed; and

e) finishing the cut surfaces with a waterproof material.

Finally, it is considered the possibility of applying a series of treatments to the shower tray made, such that after stage c), the method comprises:
the application of an anti-bacterial treatment based on silver ions, and/or
the application of anti-skid treatment based on anti-slipping polyurethane.

Thus, in accordance with the described invention, the ergonomic shower tray and the forming method of the same constitute a significant innovation in shower trays forming methods and visual appearance of these, since it allows installing said shower tray in any kind of flat support and preferably level, on the support itself, flush or even raised arranged on a stand, without having to previously make inclined planes or recesses in the own support, having a degree of elasticity that improves the ergonomics of the formed product as well as having a small number of stages in the forming of said shower tray.

### DESCRIPTION OF THE DRAWINGS

To complement the description that is being made and in order to help a better understanding of the features of the invention, in accordance with a preferred example of practical embodiment of the same, a series of figures are attached as an integral part of said description wherein with illustrative character and without limitation, the following has been represented:

FIG. 1.—It shows an elevational schematic view of the shower tray object of invention with two cross sections, a first section A-B and a second section C-D. FIG. 2.—It shows a schematic view of the cross-section area A-B shown in FIG. 1.

FIG. 3.—It shows a schematic view of the cross-section area C-D shown in FIG. 1.

FIG. 4.—It shows a perspective view of the shower tray with the corresponding drain.

### PREFERRED EMBODIMENT OF THE INVENTION

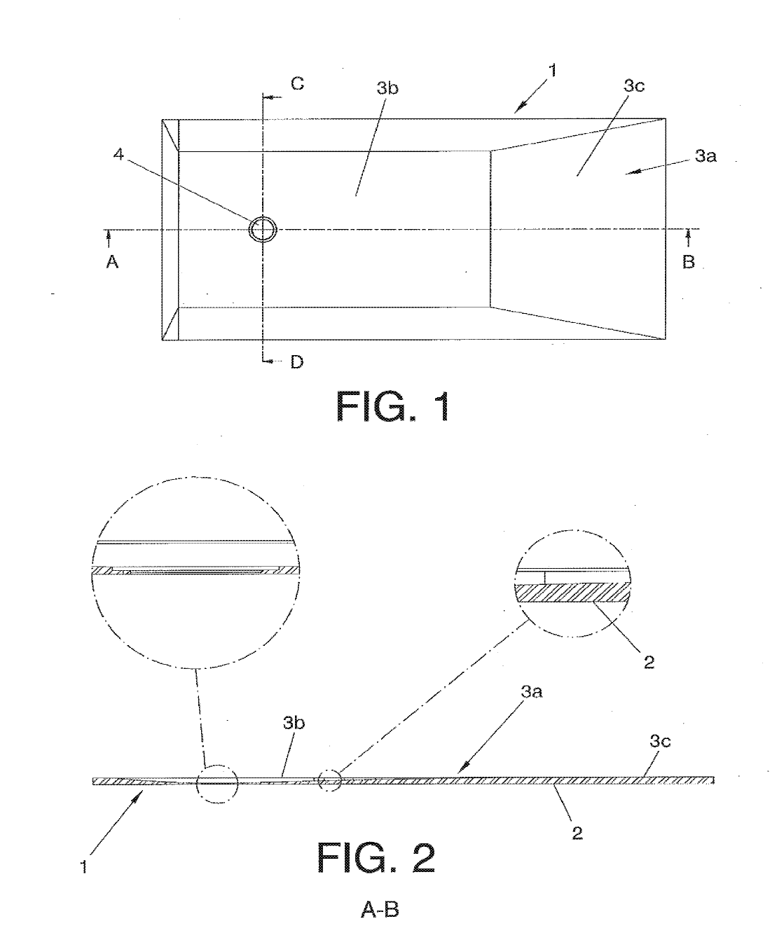

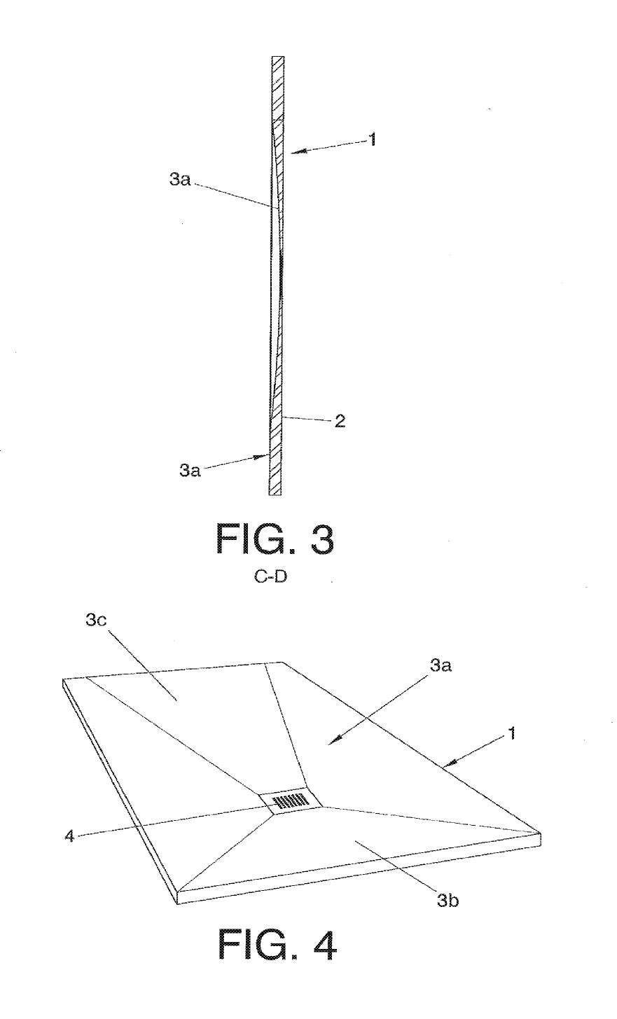

As shown in FIGS. 1 to 4, the ergonomic shower tray (1) described by the invention comprises:
A flat base surface (2) suitable to be placed on a flat surface or support; and
a series of slopes (3) located on the top surface (3a) opposite to said flat base surface (2); wherein said slopes (3) fall into a drainage channel (4) shown in FIGS. 1 and 4, in which there are two different areas, almost imperceptible for the user, having the following particularities:
   A drying area in an area (3c) adjacent to a drainage area (3b) of the shower tray (1), and defined by a series of perimeter flat surfaces suitable for the placement of a screen or similar, as well as a flat surface of less surface than the drainage area (3b) and suitable for the user to enter or exit the shower as such; and
   a drainage area (3b) or wet area around the drainage channel (4) and defined by the slopes (3) falling into the drainage channel (4) and the remaining perimeter flat surfaces.

The drainage area (3b) or wet area of the top surface (3a) of the shower tray (1) comprises a rectangular shape, in which the drainage channel is displaced with respect to the geometrical centre of the shower tray (1).

In relation to the manufacturing method of the foam shower tray (1) described above, it starts from a mould comprising the geometry of said shower tray (1), and the manufacturing method comprises the following stages:

a) Applying mould-release agents on the inner surface of the mould that forms the geometry of the shower tray (1) to be formed;

b) painting the inner surface of the mould of a final colour of the shower tray (1) to be formed;

c) injecting inside the mould a mixture of materials comprising: polyol and isocyanate for obtaining integral polyurethane, foaming agents and a small percentage of polyurethane pigments;

d) waiting for a foaming and reaction time of said previous mixture of materials, until the cooling of the mixture of materials that makes up the shower tray;

e) removing the shower tray (1) formed inside of said mould;

f) deburring the burrs present in the shower tray (1) formed; and

g) cleaning the mould-release agents from the surface of the shower tray (1) formed.

In the case that the geometry of the support on which the shower tray (1) is going to be placed, does not match the geometry of said shower tray (1), then the following stages are added:

h) Cutting the shower tray (1) formed according to the measures of a support on which it is going to be placed; and

i) finishing the cut surfaces with a waterproof material.

In view of this description and set of figures, the person skilled in the art could understand that the embodiments of the invention described can be combined in multiple ways within the object of the invention. The invention has been described according to some preferred embodiments of the same, but for the person skilled in the art it will be evident that multiple variations can be introduced in said preferred embodiments without exceeding the object of the claimed invention.

1. Ergonomic shower tray, comprising:
a flat base surface;
a top surface opposite to said flat base surface, comprising on its perimeter area, flat surfaces suitable for the placement of a screen or similar, at least one drainage channel and a drainage area around said drainage channel comprising at least one slope characterized in that
the slope of said drainage area comprises a gradient comprised in the range defined between 0.5% and 2% gradient, falling into the at least one drainage channel (4),
the top surface further comprising an area adjacent to the drainage area said adjacent area being defined by a flat surface of less surface than the drainage area;
wherein the thickness of the shower tray is comprised in the range defined between 1.75 cm and 3 cm, and
wherein the material of said shower tray is a mixture of materials comprising polyol and isocyanate for obtaining integral polyuretane, foaming agents and polyuretane pigment defining a plurality of cavities internal to the shower tray, thereby existing entrained air inside the shower tray, providing it with elasticity such that the tray is adaptable to the footprint of a user.

2. Ergonomic shower tray, according to claim 1, characterized in that the top surface comprises a waterproof surface or skin with a thickness around 2 mm, preventing the passage of water or the formation of traces of water due to osmosis.

3. Ergonomic shower tray, according to claim 1, characterized in that the drainage area has a rectangular shape with a longest side comprised between 110 cm and 150 cm.

4. Ergonomic shower tray, according to claim 3, characterized in that the drainage channel is displaced with respect to the geometrical centre of the shower tray.

5. Ergonomic shower tray, according to claim 1, characterized in that the top surface of the shower tray comprises two areas:
a wet area defined by the drainage area comprising said at least one slope and part of the perimeter flat surfaces suitable for the placement of a screen or similar; and
a drying area defined by the remaining flat surface of said top surface of the shower tray.

6. Ergonomic shower tray, according to claim 1, characterized by comprising a plate on the flat base surface, aligned in correspondence with the drainage channel of the top surface enabled to thread on the underside a drain or siphon system.

7. Ergonomic shower tray, according to claim 6, characterized in that the plate is made of galvanized iron, it has a reduced thickness and it is housed at least partially embedded in the flat base surface.

8. Manufacturing method of the ergonomic shower tray defined in claim 1, characterized in that, from a mould comprising the geometry of said shower tray, it comprises the following stages:
a) injecting inside the mould a mixture of materials comprising polyol and isocyanate for obtaining integral polyurethane, foaming agents and polyurethane pigment;
b) waiting for a foaming and reaction time of said previous mixture of materials, until the cooling of the mixture of materials that makes up the shower tray; and
c) removing the shower tray (1) formed inside of said mould,
wherein the percentage of polyurethane pigment is comprised in the range defined between 2% and 5% of the total mixture of materials, and
wherein prior to the stage a), the method further comprises the following stages:
a1) applying mould-release agents on the inner surface of the mould that forms the geometry of the shower tray to be formed; and
a2) painting said at least one inner surface of the mould of a final colour of the shower tray to be formed,
and wherein after stage c), the method comprises the following stages:
c1) deburring the burrs present in the shower tray formed; and
c2) cleaning the mould-release agents from the surface of the shower tray formed.

9-11. (canceled)

12. Manufacturing method of an ergonomic shower tray, according to claim 8, characterized in that after stage c), the method comprises the following stages:
d) cutting the shower tray formed according to the measures of a support on which it is going to be placed; and
e) finishing the cut surfaces with a waterproof material.

13. Manufacturing method of an ergonomic shower tray, according to claim 9, characterized in that the waterproof material is a mixture of polyuretane putty and water.

14. Manufacturing method of an ergonomic shower tray, according to claim 8, characterized in that after stage c2), the method comprises applying an anti-bacterial treatment based on silver ions.

15-16. (canceled)
